(19) United States
(12) Patent Application Publication
(10) Pub. No.: US 2023/0051788 A1
(43) Pub. Date: Feb. 16, 2023

(54) TECHNIQUES FOR SIDELINK CARRIER AGGREGATION

(71) Applicant: QUALCOMM Incorporated, San Diego, CA (US)

(72) Inventors: Anantharaman Balasubramanian, San Diego, CA (US); Shuanshuan Wu, San Diego, CA (US); Kapil Gulati, Belle Mead, NJ (US)

(21) Appl. No.: 17/403,559

(22) Filed: Aug. 16, 2021

(51) Int. Cl. H04L 5/00; H04W 72/04; H04B 7/08

(52) U.S. Cl. CPC H04L 5/0098; H04W 72/0453; H04B 7/088

(57) ABSTRACT

Methods, systems, and devices for wireless communications are described. A user equipment (UE) may be configured with a cross-component carrier or cross-beam quasi co-location (QCL) configuration in a sidelink carrier aggregation configuration. For example, a first beam on a first component carrier may be QCLed with a second beam on a second component carrier. The first beam may have a different beam width than the second beam or be in a different frequency range than the first beam, or both. If an application at the UE requests the UE to configure a beam on the second component carrier, the UE may use some parameters used to receive on the first component carrier to communicate using the second beam on the second component carrier.

### FIELD OF TECHNOLOGY

The following relates to wireless communications, including techniques for sidelink carrier aggregation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems support carrier aggregation techniques for sidelink communications between UEs. A UE may communicate using a first component carrier of a sidelink carrier aggregation configuration when an application at the UE triggers the UE to select a second component carrier of the carrier aggregation configuration. Techniques for configuring a component carrier for sidelink carrier aggregation may be deficient.

### SUMMARY

The described techniques relate to improved methods, systems, devices, and apparatuses that support techniques for sidelink carrier aggregation. The described techniques provide for quasi co-location (QCL) configurations across beams, component carriers, or beam widths in a sidelink carrier aggregation configuration. A user equipment (UE) may be configured to use multiple component carriers for an application at the UE. For example, a first component carrier may provide reliable but lower precision information, while a second component carrier may provide higher precision information with a narrower beam. Techniques described herein provide for a first beam on a first component carrier to be QCLed with a second beam on a second component carrier in the sidelink carrier aggregation configuration. The first beam may have a different beam width than the second beam or be in a different frequency range than the first beam, or both. If an application at the UE requests the UE to configure a beam on the second component carrier, the UE may use some parameters used to receive on the first component carrier to communicate using the second beam on the second component carrier. These techniques may be implemented when the UE is under the coverage of a base station or when the UE is outside coverage of a base station (e.g., and autonomously selecting resources).

A method for wireless communications at a UE is described. The method may include receiving control signaling indicating a QCL relationship between a first component carrier and a second component carrier, the first component carrier and the second component carrier configured in a sidelink carrier aggregation configuration, receiving, on a first beam of the first component carrier, a first transmission based on the QCL relationship, and receiving, on a second beam of the second component carrier, a second transmission according to one or more parameters used for receiving the first beam based on the QCL relationship.

An apparatus for wireless communications at a UE is described. The apparatus may include a processor, memory coupled with the processor, and instructions stored in the memory. The instructions may be executable by the processor to cause the apparatus to receive control signaling indicating a QCL relationship between a first component carrier and a second component carrier, the first component carrier and the second component carrier configured in a sidelink carrier aggregation configuration, receive, on a first beam of the first component carrier, a first transmission based on the QCL relationship, and receive, on a second beam of the second component carrier, a second transmission according to one or more parameters used for receiving the first beam based on the QCL relationship.

Another apparatus for wireless communications at a UE is described. The apparatus may include means for receiving control signaling indicating a QCL relationship between a first component carrier and a second component carrier, the first component carrier and the second component carrier configured in a sidelink carrier aggregation configuration, means for receiving, on a first beam of the first component carrier, a first transmission based on the QCL relationship, and means for receiving, on a second beam of the second component carrier, a second transmission according to one or more parameters used for receiving the first beam based on the QCL relationship.

A non-transitory computer-readable medium storing code for wireless communications at a UE is described. The code may include instructions executable by a processor to receive control signaling indicating a QCL relationship between a first component carrier and a second component carrier, the first component carrier and the second component carrier configured in a sidelink carrier aggregation configuration, receive, on a first beam of the first component carrier, a first transmission based on the QCL relationship, and receive, on a second beam of the second component carrier, a second transmission according to one or more parameters used for receiving the first beam based on the QCL relationship.

Some examples of the method, apparatuses, and non-transitory computer-readable medium described herein may further include operations, features, means, or instructions for receiving a beam activation request from an application at the UE and selecting the second beam of the second component carrier based on receiving the beam activation request from the application.

In some examples of the method, apparatuses, and non-transitory computer-readable medium described herein, receiving the second transmission may include operations, features, means, or instructions for receiving the second transmission using a spatial receive configuration of the first beam based on the QCL relationship.

In some examples of the method, apparatuses, and non-transitory computer-readable medium described herein, receiving the control signaling may include operations, features, means, or instructions for receiving an indication that the first transmission on a first set of resources may be QCLed with the second transmission on a second set of resources.

In some examples of the method, apparatuses, and non-transitory computer-readable medium described herein, receiving the control signaling may include operations, features, means, or instructions for receiving an indication that the first transmission may be quasi co-located with the second transmission based on a time offset between the first transmission and the second transmission.

In some examples of the method, apparatuses, and non-transitory computer-readable medium described herein, receiving the second transmission may include operations, features, means, or instructions for receiving the second transmission on the second beam that may have a different beam size than the first beam according to the one or more parameters based on the QCL relationship.

In some examples of the method, apparatuses, and non-transitory computer-readable medium described herein, the second beam may be wider than the first beam, or the first beam may be wider than the second beam.

In some examples of the method, apparatuses, and non-transitory computer-readable medium described herein, receiving the first transmission may include operations, features, means, or instructions for receiving, in the first transmission, an indication that the second transmission may be quasi co-located with the first transmission based on the QCL relationship between the first component carrier and the second component carrier.

In some examples of the method, apparatuses, and non-transitory computer-readable medium described herein, one or more bits in a physical broadcast channel of the first transmission include the indication that the second transmission may be quasi co-located with the first transmission.

In some examples of the method, apparatuses, and non-transitory computer-readable medium described herein, receiving the second transmission may include operations, features, means, or instructions for receiving, in the second transmission, an indication that the second transmission may be quasi co-located with the first transmission based on the QCL relationship between the first component carrier and the second component carrier.

Some examples of the method, apparatuses, and non-transitory computer-readable medium described herein may further include operations, features, means, or instructions for determining the first transmission may be quasi co-located with the second transmission based at least in part a first beam width for the first transmission on the first component carrier indicating the QCL relationship.

Some examples of the method, apparatuses, and non-transitory computer-readable medium described herein may further include operations, features, means, or instructions for selecting the second beam on the second component carrier based on an application requirement of an application, the application requirement determined based on receiving the first transmission on the first beam on the first component carrier.

In some examples of the method, apparatuses, and non-transitory computer-readable medium described herein, the application may be associated with a set of multiple application requirements corresponding to a set of multiple component carriers including at least the first component carrier and the second component carrier.

In some examples of the method, apparatuses, and non-transitory computer-readable medium described herein, the application requirement may be based on a communication range or a communication range accuracy, or both.

In some examples of the method, apparatuses, and non-transitory computer-readable medium described herein, the first transmission includes a first type of signaling which may be quasi co-located with a second type of signaling in the second transmission, where the first type of signaling may be different from the second type of signaling.

In some examples of the method, apparatuses, and non-transitory computer-readable medium described herein, the first transmission or the second transmission, or both, include a synchronization signal block, a channel state information reference signal, a sounding reference signal, or any combination thereof.

In some examples of the method, apparatuses, and non-transitory computer-readable medium described herein, the first component carrier corresponds to a first frequency range and the second component carrier corresponds to a second frequency range, where the first frequency range may be different from the second frequency range.

A method for wireless communications at a UE is described. The method may include transmitting control signaling indicating a QCL relationship between a first component carrier and a second component carrier, the first component carrier and the second component carrier configured in a carrier aggregation configuration, transmitting, on a first beam of the first component carrier, a first transmission associated with the QCL relationship, and transmitting, on a second beam of the second component carrier, a second transmission using one or more parameters for transmitting the first transmission on the first beam based on the QCL relationship.

An apparatus for wireless communications at a UE is described. The apparatus may include a processor, memory coupled with the processor, and instructions stored in the memory. The instructions may be executable by the processor to cause the apparatus to transmit control signaling indicating a QCL relationship between a first component carrier and a second component carrier, the first component carrier and the second component carrier configured in a carrier aggregation configuration, transmit, on a first beam of the first component carrier, a first transmission associated with the QCL relationship, and transmit, on a second beam of the second component carrier, a second transmission using one or more parameters for transmitting the first transmission on the first beam based on the QCL relationship.

Another apparatus for wireless communications at a UE is described. The apparatus may include means for transmitting control signaling indicating a QCL relationship between a first component carrier and a second component carrier, the first component carrier and the second component carrier configured in a carrier aggregation configuration, means for transmitting, on a first beam of the first component carrier, a first transmission associated with the QCL relationship, and means for transmitting, on a second beam of the second component carrier, a second transmission using one or more parameters for transmitting the first transmission on the first beam based on the QCL relationship.

A non-transitory computer-readable medium storing code for wireless communications at a UE is described. The code may include instructions executable by a processor to transmit control signaling indicating a QCL relationship between a first component carrier and a second component carrier, the first component carrier and the second component carrier configured in a carrier aggregation configuration, transmit, on a first beam of the first component carrier, a first transmission associated with the QCL relationship, and transmit, on a second beam of the second component carrier, a second transmission using one or more parameters for transmitting the first transmission on the first beam based on the QCL relationship.

In some examples of the method, apparatuses, and non-transitory computer-readable medium described herein, transmitting the second transmission may include operations, features, means, or instructions for transmitting the second transmission using a spatial filter configuration of the first beam based on the QCL relationship.

In some examples of the method, apparatuses, and non-transitory computer-readable medium described herein, transmitting the control signaling may include operations, features, means, or instructions for transmitting an indication that the first transmission on a first set of resources may be quasi co-located with the second transmission on a second set of resources.

In some examples of the method, apparatuses, and non-transitory computer-readable medium described herein, transmitting the control signaling may include operations, features, means, or instructions for transmitting an indication that the first transmission may be quasi co-located with the second transmission based on a time offset between the first transmission and the second transmission.

In some examples of the method, apparatuses, and non-transitory computer-readable medium described herein, transmitting the second transmission may include operations, features, means, or instructions for transmitting the second transmission on the second beam that may have a different beam size than the first beam according to the one or more parameters based on the QCL relationship.

In some examples of the method, apparatuses, and non-transitory computer-readable medium described herein, the second beam may be wider than the first beam, or the first beam may be wider than the second beam.

In some examples of the method, apparatuses, and non-transitory computer-readable medium described herein, transmitting the first transmission may include operations, features, means, or instructions for transmitting, in the first transmission, an indication that the second transmission may be quasi co-located with the first transmission based on the QCL relationship between the first component carrier and the second component carrier.

Some examples of the method, apparatuses, and non-transitory computer-readable medium described herein may further include operations, features, means, or instructions for including the indication that the second transmission may be quasi co-located with the first transmission in a physical broadcast channel of the first transmission.

In some examples of the method, apparatuses, and non-transitory computer-readable medium described herein, transmitting the second transmission may include operations, features, means, or instructions for transmitting, in the second transmission, an indication that the second transmission may be quasi co-located with the first transmission based on the QCL relationship between the first component carrier and the second component carrier.

Some examples of the method, apparatuses, and non-transitory computer-readable medium described herein may further include operations, features, means, or instructions for indicating that the first transmission may be quasi co-located with the second transmission based at least in part a first beam width for the first transmission on the first component carrier indicating the QCL relationship.

In some examples of the method, apparatuses, and non-transitory computer-readable medium described herein, the first transmission includes a first type of signaling which may be quasi co-located with a second type of signaling in the second transmission, where the first type of signaling may be different from the second type of signaling.

### BRIEF DESCRIPTION OF THE DRAWINGS

FIG. 1 illustrates an example of a wireless communications system that supports techniques for sidelink carrier aggregation in accordance with aspects of the present disclosure.

FIG. 2 illustrates an example of a wireless communications system that supports techniques for sidelink carrier aggregation in accordance with aspects of the present disclosure.

FIG. 3 illustrates an example of a process flow that supports techniques for sidelink carrier aggregation in accordance with aspects of the present disclosure.

FIGS. 4 and 5 show block diagrams of devices that support techniques for sidelink carrier aggregation in accordance with aspects of the present disclosure.

FIG. 6 shows a block diagram of a communications manager that supports techniques for sidelink carrier aggregation in accordance with aspects of the present disclosure.

FIG. 7 shows a diagram of a system including a device that supports techniques for sidelink carrier aggregation in accordance with aspects of the present disclosure.

FIGS. 8 through 11 show flowcharts illustrating methods that support techniques for sidelink carrier aggregation in accordance with aspects of the present disclosure.

### DETAILED DESCRIPTION

A user equipment (UE) may support an application which utilizes sidelink carrier aggregation. In some cases, multiple carriers may be active concurrently for an application, and each carrier may provide different levels of granularity or precision of information used by the application. The component carriers of the sidelink carrier aggregation configuration may be in the same frequency range or different frequency ranges. In some cases, the application may configure the UE to select to a component carrier which provides a higher level of precision (e.g., using a narrower beam) or to select to a component carrier which is more reliable (e.g., using a wider beam). In some systems, to establish a receive configuration on a component carrier, a UE may perform an explicit handshake with a transmitting device (e.g., a transmitting UE) in order to configure the component carrier. The handshake may involve signaling between the devices to establish beams on the component carrier. However, some applications may require low latency or prompt configuration, which may be slowed by the handshake signaling.

The described techniques relate to improved methods, systems, devices, and apparatuses that support techniques for sidelink carrier aggregation. Generally, the described techniques provide for quasi co-location (QCL) configurations across beams, component carriers, or beam widths in a sidelink carrier aggregation configuration. A UE configured with multiple component carriers for an application may communicate using a first component carrier when the UE is requested by the application to communicate using a second component carrier. For example, the UE may communicate using a first component carrier providing reliable but lower precision information, and the application may request higher precision information using the second component carrier with a narrower beam. Techniques described herein provide for a first beam on the first component carrier to be QCLed with a second beam on the second component carrier. The first beam may have a different beam width than the second beam or be in a different frequency range than the first beam, or both. When the application at the UE requests the UE to configure a beam on the second component carrier, the UE may use some parameters used to receive on the first component carrier to communicate using the second beam on the second component carrier. These techniques may be implemented when the UE is under the coverage of a base station or when the UE is outside coverage of a base station (e.g., and autonomously selecting resources).

The QCL configuration may be indicated by the transmitting UE, a base station, a roadside unit, or another example of a transmission/reception point (TRP). In some cases, the receiving UE may be preconfigured with the QCL configuration. For example, the UE may be configured with specific resources which indicate that signaling on the specific resources are QCLed together. Additionally, or alternatively, the receiving UE may determine that two signals are QCLed together based on a time gap between the signals. In some examples, certain beam widths may be configured to be QCL associated together. In some cases, information in a first transmission on the first component carrier or information in a second transmission on the second component carrier, or information in either transmission, may indicate the QCL relationship.

Aspects of the disclosure are initially described in the context of wireless communications systems. Aspects of the disclosure are further illustrated by and described with reference to apparatus diagrams, system diagrams, and flowcharts that relate to techniques for sidelink carrier aggregation.

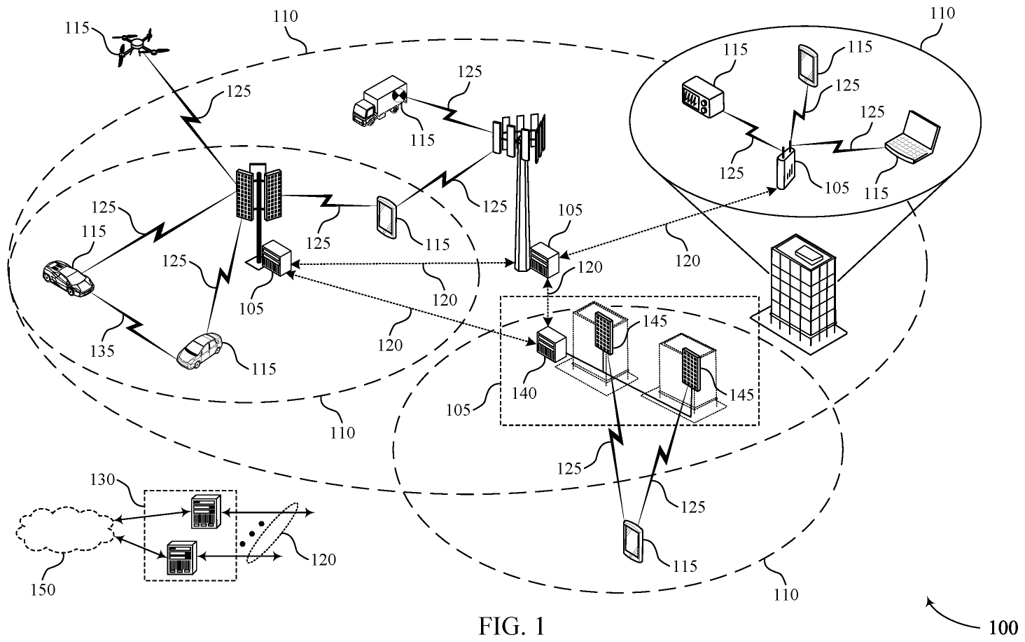

FIG. 1 illustrates an example of a wireless communications system 100 that supports techniques for sidelink carrier aggregation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or TRPs. Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARID)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support techniques for sidelink carrier aggregation. A device (e.g., a UE 115) configured for carrier aggregation may use several component carriers to improve throughput and signaling capacity within the wireless communications system 100. Sidelink carrier aggregation may be implemented to provide high bandwidth V2X scenarios, such as sensor sharing or high throughput data signaling. For example, the wireless communications system 100 may support sidelink carrier aggregation for techniques including data sharing for camera sensing, radar, light detection and ranging (LIDAR), among others.

In some cases, a carrier aggregation configuration may support carrier aggregation for homogenous component carriers or for heterogeneous component carriers. For example, the carrier aggregation configuration may have component carriers in similar type carrier frequencies (e.g., either a first radio frequency range or a second radio frequency range), or the carrier aggregation configuration may have component carriers in both the first radio frequency range and the second radio frequency range. Some example carrier frequencies include millimeter wave frequencies and sub-6 GHz frequencies, among others. In some cases, a carrier aggregation configuration may have one or more component carriers in, for example, FR1 or one or more component carriers in FR2, or have component carriers in both FR1 and FR2.

For some sidelink carrier aggregation techniques, component carriers may be mapped to or configured for applications implemented at a device. For example, an application at a UE 115 may be mapped to a set of one or more component carriers, and the UE 115 may use the set of one or more component carriers for communications associated with the application. In some cases, multiple component carriers may be configured to support an application.

Techniques described herein provide for a receiving UE 115 to select a component carrier without performing an explicit handshake with a transmitting UE 115. For example, the techniques described herein provide for configuring cross-carrier QCL associations. In some cases, a first signal transmitted using a first beam on a first component carrier may be QCLed with a second signal transmitted using a second beam on a second component carrier. In some cases, the first beam and the second beam may have different beam widths. For example, the second beam may be a narrower beam than the first beam. The receiving UE 115 may determine to communicate using the second component carrier and may use one or more same parameters to receive the second beam as the first beam. For example, the receiving UE 115 may use a same spatial receive filter for the second beam as the first beam. In some cases, the first component carrier and the second component carrier may be in the same frequency range or different frequency ranges. For example, the first component carrier may be in FR1, and the second component carrier may be in FR2.

For some aspects of these techniques, a device (e.g., a base station 105 or a UE 115) may transmit SSBs using beams of different beam widths across different carriers. The beams used to transmit the SSBs across carriers may be QCLed such that a receiving UE 115 can determine that a carrier is available to be used for an application from any SSB beams decoded by the receiving UE 115. For example, the receiving UE 115 may receive, for an application, a first SSB on a first beam on a first component carrier and receive a second SSB on a second beam on a second component carrier. The first SSB may be QCLed with the second SSB such that the receiving UE 115 may select to use the second beam on the second component carrier for the application. In some cases, the transmitting device may transmit control signaling to configure the receiving UE 115 with the QCL relationship between carriers, beams, beam widths, SSBs, or any combination thereof.

For example, a UE 115 may be under coverage of a base station 105, or a roadside unit, and the UE 115 may support communication in a first set of component carriers. For example, the UE 115 may be configured for communications on n component carriers, including carriers from {C1, C2, . . . Cn}. The first set of component carriers may include component carriers in a first frequency range (e.g., FR1) or a second frequency range (e.g., FR2), or both. A UE 115 may implement techniques described herein to perform carrier selection for different applications. In some cases, the base station 105 or the roadside unit may transmit signaling to enable application-specific carrier selection at the UE 115.

In another example, a first UE 115 and a second UE 115 may not be within a coverage area of a base station 105 or a roadside unit. The first UE 115 and the second UE 115 may perform autonomous resources selection for sidelink communications, which may be referred to as Mode 2 operation for sidelink communications. The first UE 115 (e.g., a transmitting UE 115) may select an SSB to transmit on a designated or selected primary component carrier. Different SSB beam widths may be QCLed across carriers such that the second UE 115 (e.g., a receiving UE 115) can communicate using a same beam direction with a different sized beam. For example, the UEs 115 may implement techniques described herein to provide different modes of carrier selection (e.g., for FR1 or FR2, or both) while configured for Mode 2-based operation.

The QCL association may be configured based on resources, a time offset, explicit signaling, beam width, or any combination thereof. For example, the transmitting UE 115 may indicate that a first signal on a first component carrier is QCLed with a second signal on a second component carrier based on a first resource used to transmit the first signal and a second resource used to transmit the second signal. The mapping may, in some cases, be configured via control signaling or may be preconfigured at the transmitting UE 115 or the receiving UE 115, or both. Additionally, or alternatively, a time offset between the first signal and the second signal may indicate that the first signal on the first component carrier is QCLed with the second signal on the second component carrier. These techniques may provide for a receiving UE 115 to activate and configure a receive beam on the second component carrier using some parameters associated with the first beam or the first component carrier, or both, without performing additional signaling exchanges with the transmitting UE 115, enabling the receiving UE 115 to quickly establish the receive beam on the second component carrier.

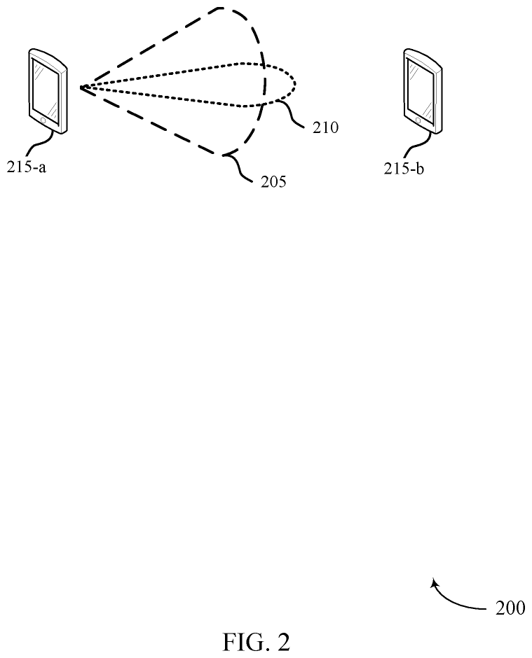

FIG. 2 illustrates an example of a wireless communications system 200 that supports techniques for sidelink carrier aggregation in accordance with aspects of the present disclosure. The wireless communications system 200 includes a UE 215-a and a UE 215-b, which may each be an example of a UE 115 of the wireless communications system 100. In some cases, the wireless communications system 200 may include one or more base stations 105, TRPs, or other devices.

The wireless communications system 200 may support techniques for sidelink carrier aggregation. A device (e.g., a UE 115) configured for carrier aggregation may use several component carriers to improve throughput and signaling capacity within the wireless communications system 200. Sidelink carrier aggregation may be implemented to provide high bandwidth V2X scenarios, such as sensor sharing or high throughput data signaling. For example, the wireless communications system 200 may support sidelink carrier aggregation for techniques including data sharing for camera sensing, radar, light detection and ranging (LIDAR), among others.

In some cases, the UE 215-b may be under the coverage of a base station 105 (or a roadside unit, TRP, etc.), and the base station 105 may configure the UE 215-b with a set of component carriers. The set of component carriers may be mapped to or configured for an application implemented at the UE 215-b. For example, the UE 215-b may use the set of component carriers for communications associated with the application. In some cases, multiple component carriers may be configured to support an application. For example, the UE 215-b may be configured with n carriers, including carriers C1 through Cn. The set of carriers may include carriers belonging to just FR1 or just FR2, or carriers from both FR1 and FR2. In some cases, this mode of operation may be referred to as Mode 1 operation. In some examples for Mode 1 operation, the base station 105 may assign, and in some cases schedule, resources for sidelink communications between UEs 115 such as the UE 215-a and the UE 215-b.

In another example, the UE 215-a and the UE 215-b may not be within the coverage of a base station 105. For example, the UE 215-a and the UE 215-b may autonomously select resources for sidelink communications instead of being assigned resources by a base station 105. In some cases, this mode of operation may be referred to as Mode 2 operation.

The UE 215-a or the UE 215-b, or both, may implement some applications which utilize V2X communications or V2X communication services. For example, the UE 215-b may perform positioning techniques using an application at the UE 215-b. The UE 215-b may be configured to communicate on a first component carrier for some signaling, while advanced applications such as positioning or sensor sharing may utilize greater bandwidth and may be performed using narrower beams on a second component carrier. For example, a basic safety message (BSM) transmission may be performed over a wider beam on the first component carrier. As an example, the UE 215-a may transmit the BSM transmission using a beam 205 on the first component carrier to UE 215-b.

The UE 215-b may use a beam 215 to receive the BSM across the first component carrier and determine positioning information based on the BSM. In some cases, the UE 215-b may detect high uncertainty in the positioning information or angle of arrival, or both, based on the BSM transmitted using the beam 205 on the first component carrier. An application at the UE 215-b may configure the UE 215-b to perform more accurate measurements. For example, the positioning measurements from the beam 205 on the first component carrier may not satisfy a threshold (e.g., a precision threshold, a certainty threshold, etc.), and the application at the UE 215-b may request more accurate measurements. The UE 215-b may use the second component carrier for more precise measurements, but the UE 215-b may not have a beam established for the second component carrier. In other systems, a UE 115 may perform an extensive beam establishment and configuration procedure to determine beam parameters for a newly established beam.

The wireless communications system 200 may support techniques for configuring a QCL association across beams, such as across beams of different component carriers of a sidelink carrier aggregation configuration or across beams of different beam widths. These techniques may provide fast beam establishment on component carriers of a sidelink carrier aggregation configuration by configuring a QCL association between beams, beam widths, component carriers, frequency ranges, or any combination thereof

For example, when the UE 215-b determines to activate a beam (e.g., a beam 220) on the second component carrier to perform more precise measurements, the UE 215-b may reuse some parameters which are used to receive the beam 205 on the first component carrier in order to receive a more narrow beam (e.g., a beam 210) on the second component carrier. The UE 215-b may determine to use the beam parameters to receive the beam 210 based on a configured QCL relationship, such as a QCL relationship between the first component carrier and the second component carrier. For example, the UE 215-b may use a same spatial filter to receive the beam 205 and the beam 210. Additionally, or alternatively, the UE 215-b may use other beam parameters to receive the beam 210 which may be used to receive the beam 205, and the other beam parameters. In some cases, the UE 215-b may track the beam 210 transmitted over the second component carrier using a mapped or same spatial filter used for the first component carrier to improve reliability.

The UE 215-a or the UE 215-b, or both, may implement these techniques to perform carrier selection, such as application-specific carrier selection. When operating in Mode 1, a base station 105 may transmit control signaling to the UE 215-a or the UE 215-b, or both, to configure a QCL association between component carriers to support carrier selection for different applications. For example, the base station 105 may transmit SSBs of different beam widths across different carriers. The SSB beams across carriers may be QCLed such that the UE 215-b can infer the carrier across which a certain beam width (e.g., which is configured to be used for a certain application) is available from any of the SSBs the UE 215-b is able to decode.

When operating in Mode 2, the UE 215-b may also implement described herein for carrier selection in a sidelink carrier aggregation configuration. For example, the UE 215-a may select a specific SSB to transmit on a designated or selected primary component carrier. Different SSB beam widths may be QCLed across component carriers such that UE 215-b may communicate along a beam direction (e.g., a desired, requested, or configured beam width direction) based on an application requirement of an application at UE 215-b.

For example, a wireless device, such as the UE 215-a, may transmit a first SSB and a second SSB to the UE 215-b. The UE 215-a may transmit the first SSB on a first set of resources (e.g., preconfigured or selected resources) using a first beam (e.g., the beam 205) with a first beam width in a first component carrier. The UE 215-a may transmit the second SSB on a second set of resources (e.g., preconfigured or selected resources) using a second beam (e.g., the beam 210) with a second beam width in a second component carrier. In some cases, the first component carrier may be in FR1 and the second component carrier may be in FR2. In some cases, the first beam width may be wider than the second beam width. In this example, the UE 215-a may transmit the first SSB and the second SSB. In other examples, another wireless device, such as a base station 105, a TRP, or a roadside unit, may transmit the first SSB and the second SSB.

The UE 215-b may determine a QCL configuration associating the first component carrier and the second component carrier. For example, the UE 215-a may indicate, or imply, a QCL relationship that a spatial receive direction used by the UE 215-b on the first component carrier to decode the wider beam may be the same as a spatial receive direction to decode the narrower beam on the second component carrier.

In some cases, a spatial receive filter mapping between the wider beam on the first component carrier and the narrower beam on the second component carrier may be preconfigured or signaled. For example, the spatial receive filter mapping between the wider and the narrow beam may be indicated in the first SSB or the second SSB, or both. For example, the mapping information may be indicated using one or more bits in a physical broadcast channel (PBCH) of the first SSB or the second SSB, or both. In some cases, a QCL relationship for transmission of the second beam with the second beam width in the second component carrier may be implied by the UE 215-a transmitting using the first beam with the first beam width in the first component carrier. For example, switching from transmitting using the first beam on the first component carrier to transmitting using the second beam on the second component carrier may implicitly indicate the QCL association between the first beam on the first component carrier and the second beam on the second component carrier.

In some cases, a QCL association may be configured, or indicated, based on a time offset between transmissions. For example, the UE 215-a may transmit a first SSB on a first beam (e.g., the beam 205) with a first beam width on a set of resources in a component carrier. The UE 215-a may also transmit a second SSB using a second beam (e.g., the beam 210) with a second beam width on the set of resources in the component carrier. A time offset between the first SSB (e.g., transmitted using the first beam) and the second SSB (e.g., transmitted using the second beam) may indicate a QCL association between the first beam and the second beam. For example, the UE 215-b may receive the first SSB and receive the second SSB after the time offset. The UE 215-b may determine that the first SSB and the second SSB are QCLed based on being transmitted with the time offset between the first SSB and the second SSB. The UE 215-b may then use one or more parameters to receive signals transmitted using the second beam which are also used to receive signals transmitted using the first beam. For example, the UE 215-b may use a same spatial filter to receive signaling from the beam 205 and the beam 210 based on the QCL association between the first SSB and the second SSB, even if the beam 205 has a different beam width than the beam 210. In some cases, the time offset between the first transmission and the second transmission may be preconfigured, or the time offset between the beams may be signaled, such as in the first SSB or the second SSB, or both. For example, one or more bits in a PBCH of the first or second SSB, or both, may indicate the time offset.

In some cases, different types of signals may be QCLed together. The wireless communications system 200 may support the QCL association between different QCL beam measurement sources or signals. For example, the QCL association may be between heterogenous signals, including CSI-RS, SSBs, SRS, or any combination thereof. In an example, a wireless device (e.g., the UE 215-a, a base station 105, a TRP, etc.) may transmit a wider beam SSB in a first carrier, transmit a first narrow beam CSI-RS in a second component carrier, and transmit a second narrow beam CSI-RS in a third component carrier. The wider beam SSB may be QCLed with the first narrow beam CSI-RS or the second narrow beam CSI-RS, or both. The UE 215-b may determine to use (e.g., reuse from the wider beam SSB) one or more parameters to receive signaling on a narrow beam on the second component carrier or the third component carrier, or both.

In another example, the wireless device may transmit a wider beam CSI-RS on a first component carrier using a first beam width, transmit a first narrow beam CSI-RS on a second component carrier using a second beam width, and transmit a second narrow beam CSI-RS on a third component carrier using a third beam width, where the first beam width is wider than the second beam width, and the second beam width is wider than the third beam width. In some cases, the UE 215-b may determine to reuse parameters to receive signaling on the first component carrier with the first beam width based on a QCL association between the wider beam CSI-RS and the first or second narrow beam CSI-RSs, or both. Additionally, or alternatively, the UE 215-b may determine to reuse parameters to receive signaling on the second component carrier with the second beam width based on a QCL association between the first narrow beam CSI-RS and the wider beam CSI-RS or the second narrow beam CSI-RS, or both.

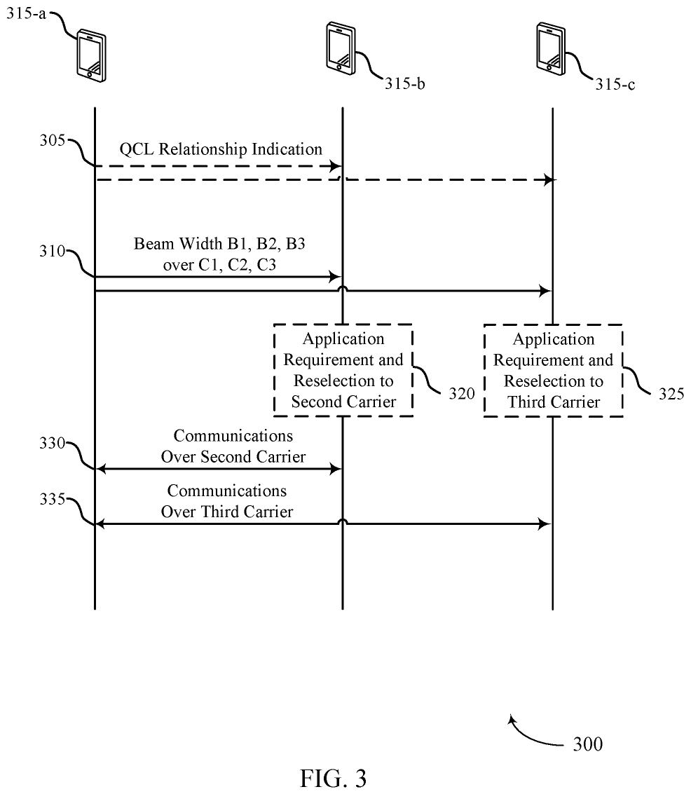

FIG. 3 illustrates an example of a process flow 300 that supports techniques for sidelink carrier aggregation in accordance with aspects of the present disclosure. The process flow 300 may be implemented by a UE 315-a, a UE 315-b, or a UE 315-c, or any combination thereof, each of which may be an example of a UE 115 as described with reference to FIGS. 1 and 2. In some examples, some signaling or processes of the process flow 300 may be performed by another wireless device, such as a base station 105, an RSU, or a TRP. For example, some signaling and procedures performed by the UE 315-a may be performed by a base station 105, TRP, or RSU. In the following description of the process flow 300, the operations between the UE 315-a, the UE 315-b, and the UE 315-c may be performed in different orders or at different times. Certain operations may also be left out of the process flow 300, or other operations may be added.

At 305, UE 315-b or UE 315-c, or both, may receive control signaling indicating a QCL relationship between a first component carrier and a second component carrier. The the first component carrier and the second component carrier may be configured in a sidelink carrier aggregation configuration. In some cases, an application at UE 315-b may have configured three levels of granularity, precision, or requirement for different component carriers in the carrier aggregation. For example, UE 315-b may be configured to use the first component carrier for a first type or level of service and use the second component carrier for a second type or level of service, where the second component carrier may provide higher granularity or higher precision information than the first component carrier for the application.

In some cases, UE 315-a may transmit the control signaling indicating the QCL relationship between the first component carrier and the second component carrier. Additionally, or alternatively, a base station 105 may configure the QCL relationship between the first component carrier and the second component carrier. For example, if operating on Mode 1 (e.g., within coverage of a base station 105), the base station 105 may configure the QCL relationship information at the UEs 115. Additionally, or alternatively, if operating in Mode 2, UE 315-a may indicate the QCL relationship information.

At 310, UE 315-a may transmit using a first beam with a first beam width on the first component carrier, using a second beam with a second beam width on the second component carrier, and using a third beam with a third beam width on a third component carrier. For example, UE 315-a may transmit a first signal (e.g., a first CSI-RS, first SSB, etc.) using the first beam on the first component carrier, a second signal (e.g., a second CSI-RS, a second SSB, etc.) using the second beam on the second component carrier, and a third signal (e.g., a third CSI-RS, a third SSB, etc.) using the third beam on the third component carrier. In some cases, the first signal may include an indication that the first signal is QCLed with the second signal or the third signal, or both. For example, one or more bits in a PBCH of the first SSB may indicate that the first SSB is QCLed with another transmission (e.g., the third second signal or the third signal). In some cases, the first beam may be wider than the second beam, and the second beam may be wider than the first beam. For example, the first beam may be a wide beam, and the second and third beams may be narrow beams.

UE 315-b may receive, on the first beam of the first component carrier, a first transmission based on the QCL relationship. For example, UE 315-b may receive the first signal (e.g., the first SSB, the first CSI-RS, etc.). In some cases, UE 315-c may also receive the first transmission on the first beam of the first component carrier.

In some cases, an application requirement may configure UE 315-b to reselect to the second component carrier at 320. For example, UE 315-b may receive the first transmission on the first beam of the first component carrier, and an application at UE 315-b may request or require higher precision, higher granularity, or another requirement, for information obtained from the first transmission. The application layer at UE 315-b may configure UE 315-b to configure reselect to the second component carrier for higher granularity or higher precision information.

UE 315-b may determine some parameters to receive the second beam on the second component carrier based on the QCL relationship between the first component carrier and the second component carrier. For example, UE 315-b may determine to use a same spatial receive filter for communications on the second component carrier as the spatial receive filter used for communications on the first component carrier. Other parameters may also be configured, which UE 315-b may reuse to communicate on the second component carrier. With the configured QCL relationship, UE 315-b may refrain from performing an extensive handshake procedure with UE 315-a to establish a beam for the second component carrier, instead reusing some parameters used for communications on the first beam of the first component carrier. For example, UE 315-b decoding the wider beam on the first component carrier with a first spatial filter may reselect to the second component carrier to perform advanced operations for the application and may use the first spatial filter for communications with the narrower beam (e.g., the second beam) on the second component carrier.

At 330, UE 315-b may transmit and receive on the second component carrier, communicating with UE 315-a using the second beam on the second component carrier. For example, UE 315-b may receive, on the second beam of the second component carrier, a second transmission according to one or more parameters used for receiving the first beam based on the QCL relationship. For example, UE 315-b may communicate on the second component carrier using one or more same parameters used to receive signaling on the first component carrier.

Similarly, an application requirement may configure UE 315-c to reselect to the third component carrier at 325. For example, UE 315-c may receive the first transmission on the first beam of the first component carrier, and an application at UE 315-c may request or require higher precision, higher granularity, or another requirement, for information obtained from the first transmission. The application layer at UE 315-c may configure UE 315-c to configure reselect to the third component carrier for higher granularity or higher precision information. UE 315-c may similarly determine some parameters to receive the third beam on the third component carrier based on the QCL relationship between the first component carrier and the third component carrier. With the configured QCL relationship, UE 315-c may refrain from performing an extensive handshake procedure with UE 315-a to establish a beam for the third component carrier, instead reusing some parameters used for communications on the first beam of the first component carrier at 335.

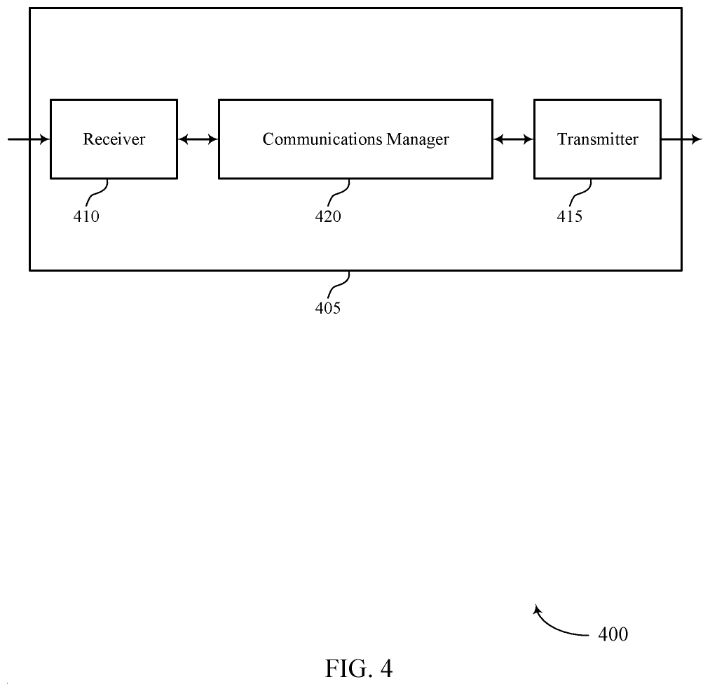

FIG. 4 shows a block diagram 400 of a device 405 that supports techniques for sidelink carrier aggregation in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for sidelink carrier aggregation). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for sidelink carrier aggregation). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for sidelink carrier aggregation as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communications at a UE in accordance with examples as disclosed herein. For example, the communications manager 420 may be configured as or otherwise support a means for receiving control signaling indicating a QCL relationship between a first component carrier and a second component carrier, the first component carrier and the second component carrier configured in a sidelink carrier aggregation configuration. The communications manager 420 may be configured as or otherwise support a means for receiving, on a first beam of the first component carrier, a first transmission based on the QCL relationship. The communications manager 420 may be configured as or otherwise support a means for receiving, on a second beam of the second component carrier, a second transmission according to one or more parameters used for receiving the first beam based on the QCL relationship.

Additionally or alternatively, the communications manager 420 may support wireless communications at a UE in accordance with examples as disclosed herein. For example, the communications manager 420 may be configured as or otherwise support a means for transmitting control signaling indicating a QCL relationship between a first component carrier and a second component carrier, the first component carrier and the second component carrier configured in a carrier aggregation configuration. The communications manager 420 may be configured as or otherwise support a means for transmitting, on a first beam of the first component carrier, a first transmission associated with the QCL relationship. The communications manager 420 may be configured as or otherwise support a means for transmitting, on a second beam of the second component carrier, a second transmission using one or more parameters for transmitting the first transmission on the first beam based on the QCL relationship.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for more efficient utilization of communication resources by reducing the amount of signaling between devices to establish a communications link on a component carrier.

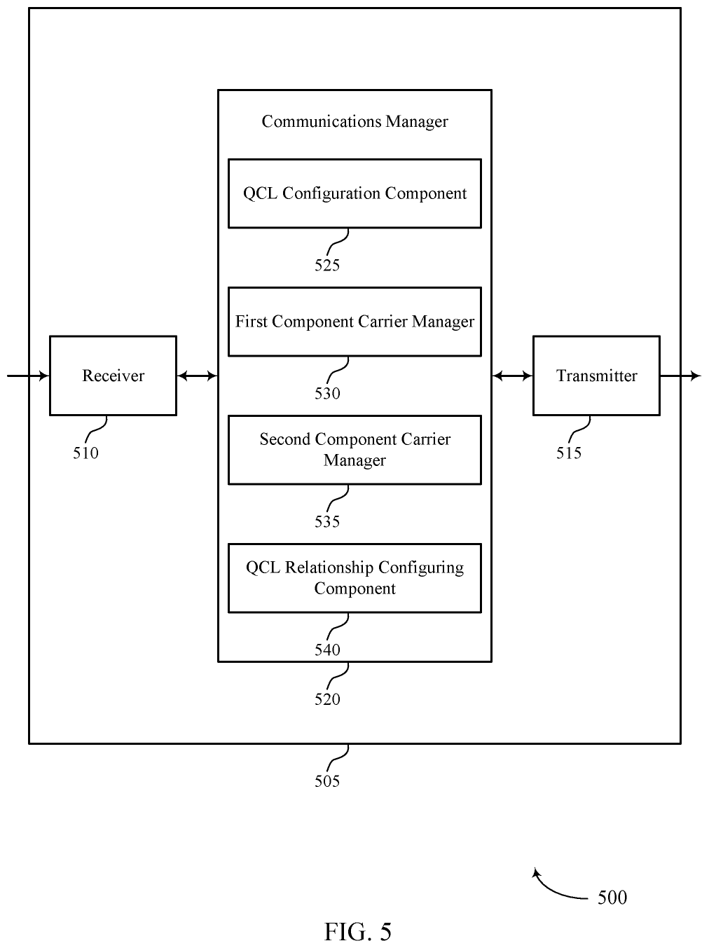

FIG. 5 shows a block diagram 500 of a device 505 that supports techniques for sidelink carrier aggregation in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for sidelink carrier aggregation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for sidelink carrier aggregation). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for sidelink carrier aggregation as described herein. For example, the communications manager 520 may include a QCL configuration component 525, a first component carrier manager 530, a second component carrier manager 535, a QCL relationship configuring component 540, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. The QCL configuration component 525 may be configured as or otherwise support a means for receiving control signaling indicating a QCL relationship between a first component carrier and a second component carrier, the first component carrier and the second component carrier configured in a sidelink carrier aggregation configuration. The first component carrier manager 530 may be configured as or otherwise support a means for receiving, on a first beam of the first component carrier, a first transmission based on the QCL relationship. The second component carrier manager 535 may be configured as or otherwise support a means for receiving, on a second beam of the second component carrier, a second transmission according to one or more parameters used for receiving the first beam based on the QCL relationship.

Additionally or alternatively, the communications manager 520 may support wireless communications at a UE in accordance with examples as disclosed herein. The QCL relationship configuring component 540 may be configured as or otherwise support a means for transmitting control signaling indicating a QCL relationship between a first component carrier and a second component carrier, the first component carrier and the second component carrier configured in a carrier aggregation configuration. The first component carrier manager 530 may be configured as or otherwise support a means for transmitting, on a first beam of the first component carrier, a first transmission associated with the QCL relationship. The second component carrier manager 535 may be configured as or otherwise support a means for transmitting, on a second beam of the second component carrier, a second transmission using one or more parameters for transmitting the first transmission on the first beam based on the QCL relationship.

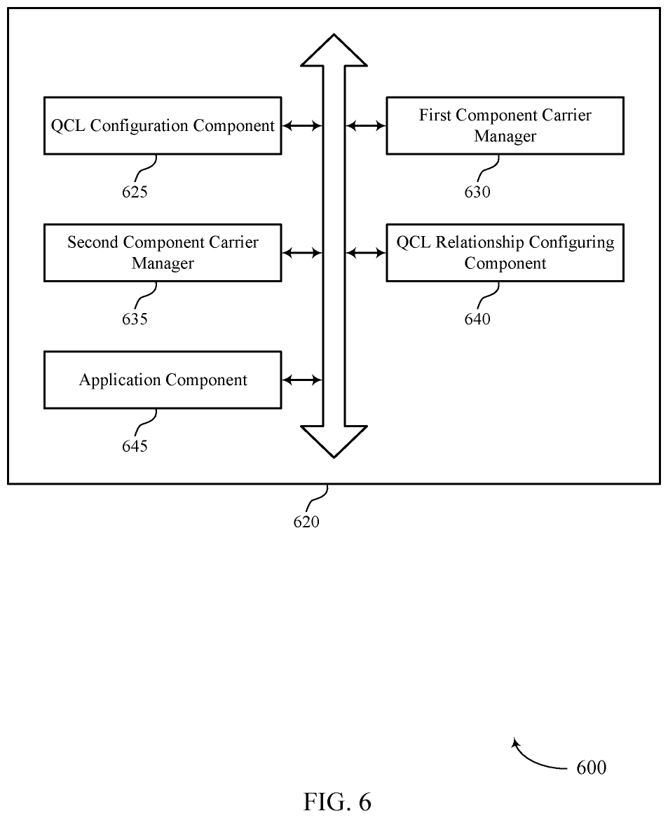

FIG. 6 shows a block diagram 600 of a communications manager 620 that supports techniques for sidelink carrier aggregation in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for sidelink carrier aggregation as described herein. For example, the communications manager 620 may include a QCL configuration component 625, a first component carrier manager 630, a second component carrier manager 635, a QCL relationship configuring component 640, an application component 645, or any combination thereof. Each of these components may communicate, directly or indirectly, with one another (e.g., via one or more buses).

The communications manager 620 may support wireless communications at a UE in accordance with examples as disclosed herein. The QCL configuration component 625 may be configured as or otherwise support a means for receiving control signaling indicating a QCL relationship between a first component carrier and a second component carrier, the first component carrier and the second component carrier configured in a sidelink carrier aggregation configuration. The first component carrier manager 630 may be configured as or otherwise support a means for receiving, on a first beam of the first component carrier, a first transmission based on the QCL relationship. The second component carrier manager 635 may be configured as or otherwise support a means for receiving, on a second beam of the second component carrier, a second transmission according to one or more parameters used for receiving the first beam based on the QCL relationship.

In some examples, the application component 645 may be configured as or otherwise support a means for receiving a beam activation request from an application at the UE. In some examples, the application component 645 may be configured as or otherwise support a means for selecting the second beam of the second component carrier based on receiving the beam activation request from the application.

In some examples, to support receiving the second transmission, the second component carrier manager 635 may be configured as or otherwise support a means for receiving the second transmission using a spatial receive configuration of the first beam based on the QCL relationship.

In some examples, to support receiving the control signaling, the QCL configuration component 625 may be configured as or otherwise support a means for receiving an indication that the first transmission on a first set of resources is quasi co-located with the second transmission on a second set of resources.

In some examples, to support receiving the control signaling, the QCL configuration component 625 may be configured as or otherwise support a means for receiving an indication that the first transmission is quasi co-located with the second transmission based on a time offset between the first transmission and the second transmission.

In some examples, to support receiving the second transmission, the second component carrier manager 635 may be configured as or otherwise support a means for receiving the second transmission on the second beam that has a different beam size than the first beam according to the one or more parameters based on the QCL relationship.

In some examples, the second beam is wider than the first beam, or the first beam is wider than the second beam.

In some examples, to support receiving the first transmission, the QCL configuration component 625 may be configured as or otherwise support a means for receiving, in the first transmission, an indication that the second transmission is quasi co-located with the first transmission based on the QCL relationship between the first component carrier and the second component carrier.

In some examples, one or more bits in a PBCH of the first transmission include the indication that the second transmission is quasi co-located with the first transmission.

In some examples, to support receiving the second transmission, the QCL configuration component 625 may be configured as or otherwise support a means for receiving, in the second transmission, an indication that the second transmission is quasi co-located with the first transmission based on the QCL relationship between the first component carrier and the second component carrier.

In some examples, the QCL configuration component 625 may be configured as or otherwise support a means for determining the first transmission is quasi co-located with the second transmission based at least in part a first beam width for the first transmission on the first component carrier indicating the QCL relationship.

In some examples, the application component 645 may be configured as or otherwise support a means for selecting the second beam on the second component carrier based on an application requirement of an application, the application requirement determined based on receiving the first transmission on the first beam on the first component carrier.

In some examples, the application is associated with a set of multiple application requirements corresponding to a set of multiple component carriers including at least the first component carrier and the second component carrier.

In some examples, the application requirement is based on a communication range or a communication range accuracy, or both.

In some examples, the first transmission includes a first type of signaling which is quasi co-located with a second type of signaling in the second transmission, where the first type of signaling is different from the second type of signaling.

In some examples, the first transmission or the second transmission, or both, include a synchronization signal block, a channel state information reference signal, a sounding reference signal, or any combination thereof.

In some examples, the first component carrier corresponds to a first frequency range and the second component carrier corresponds to a second frequency range, where the first frequency range is different from the second frequency range.

Additionally or alternatively, the communications manager 620 may support wireless communications at a UE in accordance with examples as disclosed herein. The QCL relationship configuring component 640 may be configured as or otherwise support a means for transmitting control signaling indicating a QCL relationship between a first component carrier and a second component carrier, the first component carrier and the second component carrier configured in a carrier aggregation configuration. In some examples, the first component carrier manager 630 may be configured as or otherwise support a means for transmitting, on a first beam of the first component carrier, a first transmission associated with the QCL relationship. In some examples, the second component carrier manager 635 may be configured as or otherwise support a means for transmitting, on a second beam of the second component carrier, a second transmission using one or more parameters for transmitting the first transmission on the first beam based on the QCL relationship.

In some examples, to support transmitting the second transmission, the QCL relationship configuring component 640 may be configured as or otherwise support a means for transmitting the second transmission using a spatial filter configuration of the first beam based on the QCL relationship.

In some examples, to support transmitting the control signaling, the QCL relationship configuring component 640 may be configured as or otherwise support a means for transmitting an indication that the first transmission on a first set of resources is quasi co-located with the second transmission on a second set of resources.

In some examples, to support transmitting the control signaling, the QCL relationship configuring component 640 may be configured as or otherwise support a means for transmitting an indication that the first transmission is quasi co-located with the second transmission based on a time offset between the first transmission and the second transmission.

In some examples, to support transmitting the second transmission, the second component carrier manager 635 may be configured as or otherwise support a means for transmitting the second transmission on the second beam that has a different beam size than the first beam according to the one or more parameters based on the QCL relationship.

In some examples, the second beam is wider than the first beam, or the first beam is wider than the second beam.

In some examples, to support transmitting the first transmission, the first component carrier manager 630 may be configured as or otherwise support a means for transmitting, in the first transmission, an indication that the second transmission is quasi co-located with the first transmission based on the QCL relationship between the first component carrier and the second component carrier.

In some examples, the first component carrier manager 630 may be configured as or otherwise support a means for including the indication that the second transmission is quasi co-located with the first transmission in a PBCH of the first transmission.

In some examples, to support transmitting the second transmission, the QCL relationship configuring component 640 may be configured as or otherwise support a means for transmitting, in the second transmission, an indication that the second transmission is quasi co-located with the first transmission based on the QCL relationship between the first component carrier and the second component carrier.

In some examples, the QCL relationship configuring component 640 may be configured as or otherwise support a means for indicating that the first transmission is quasi co-located with the second transmission based at least in part a first beam width for the first transmission on the first component carrier indicating the QCL relationship.

In some examples, the first transmission includes a first type of signaling which is quasi co-located with a second type of signaling in the second transmission, where the first type of signaling is different from the second type of signaling.

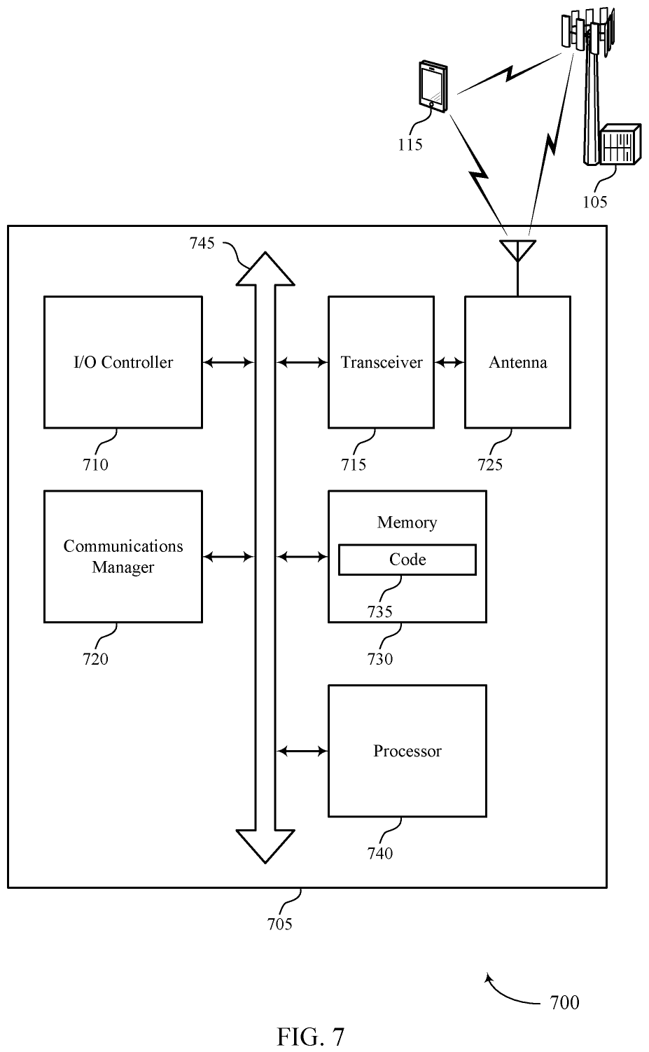

FIG. 7 shows a diagram of a system 700 including a device 705 that supports techniques for sidelink carrier aggregation in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for sidelink carrier aggregation). For example, the device 705 or a component of the device 705 may include a processor 740 and memory 730 coupled to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving control signaling indicating a QCL relationship between a first component carrier and a second component carrier, the first component carrier and the second component carrier configured in a sidelink carrier aggregation configuration. The communications manager 720 may be configured as or otherwise support a means for receiving, on a first beam of the first component carrier, a first transmission based on the QCL relationship. The communications manager 720 may be configured as or otherwise support a means for receiving, on a second beam of the second component carrier, a second transmission according to one or more parameters used for receiving the first beam based on the QCL relationship.

Additionally or alternatively, the communications manager 720 may support wireless communications at a UE in accordance with examples as disclosed herein. For example, the communications manager 720 may be configured as or otherwise support a means for transmitting control signaling indicating a QCL relationship between a first component carrier and a second component carrier, the first component carrier and the second component carrier configured in a carrier aggregation configuration. The communications manager 720 may be configured as or otherwise support a means for transmitting, on a first beam of the first component carrier, a first transmission associated with the QCL relationship. The communications manager 720 may be configured as or otherwise support a means for transmitting, on a second beam of the second component carrier, a second transmission using one or more parameters for transmitting the first transmission on the first beam based on the QCL relationship.

By including or configuring the communications manager 720 in accordance with examples as described herein, the device 705 may support techniques for lower latency communications by reducing signaling to establish a communications link on a component carrier of a sidelink carrier aggregation configuration.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for sidelink carrier aggregation as described herein, or the processor 740 and the memory 730 may be otherwise configured to perform or support such operations.

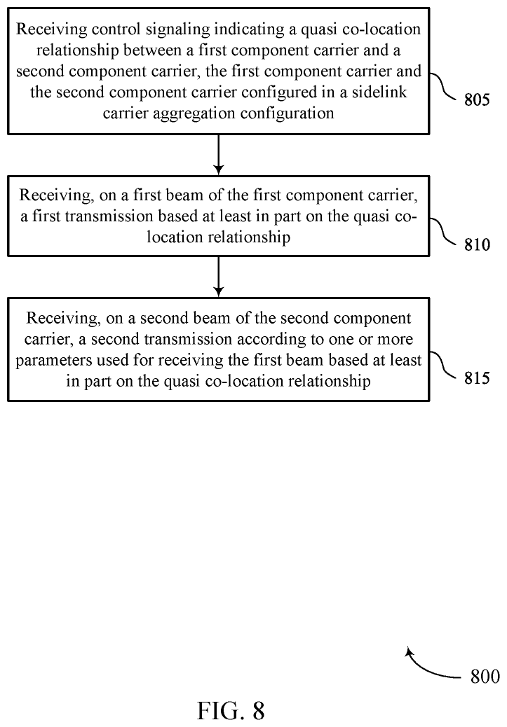

FIG. 8 shows a flowchart illustrating a method 800 that supports techniques for sidelink carrier aggregation in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 805, the method may include receiving control signaling indicating a QCL relationship between a first component carrier and a second component carrier, the first component carrier and the second component carrier configured in a sidelink carrier aggregation configuration. The operations of 805 may be performed in accordance with examples as disclosed herein. In some examples, aspects of the operations of 805 may be performed by a QCL configuration component 625 as described with reference to FIG. 6.

At 810, the method may include receiving, on a first beam of the first component carrier, a first transmission based on the QCL relationship. The operations of 810 may be performed in accordance with examples as disclosed herein. In some examples, aspects of the operations of 810 may be performed by a first component carrier manager 630 as described with reference to FIG. 6.

At 815, the method may include receiving, on a second beam of the second component carrier, a second transmission according to one or more parameters used for receiving the first beam based on the QCL relationship. The operations of 815 may be performed in accordance with examples as disclosed herein. In some examples, aspects of the operations of 815 may be performed by a second component carrier manager 635 as described with reference to FIG. 6.

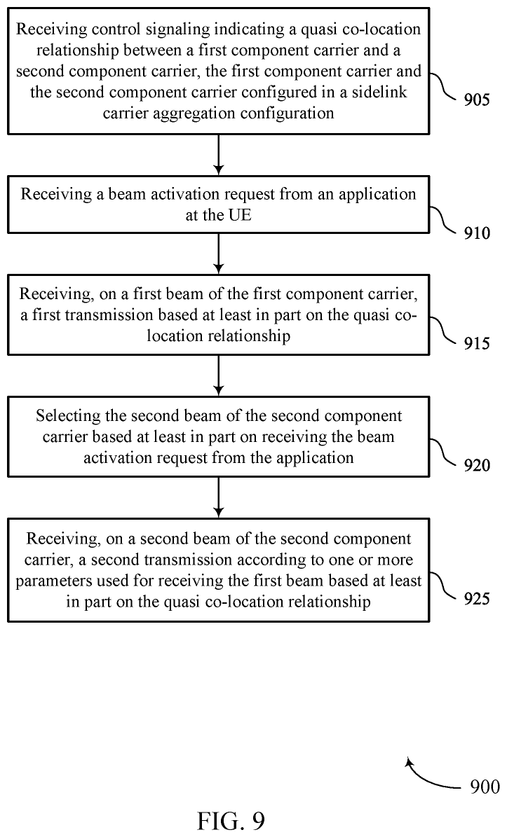

FIG. 9 shows a flowchart illustrating a method 900 that supports techniques for sidelink carrier aggregation in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 905, the method may include receiving control signaling indicating a QCL relationship between a first component carrier and a second component carrier, the first component carrier and the second component carrier configured in a sidelink carrier aggregation configuration. The operations of 905 may be performed in accordance with examples as disclosed herein. In some examples, aspects of the operations of 905 may be performed by a QCL configuration component 625 as described with reference to FIG. 6.

At 910, the method may include receiving a beam activation request from an application at the UE. The operations of 910 may be performed in accordance with examples as disclosed herein. In some examples, aspects of the operations of 910 may be performed by an application component 645 as described with reference to FIG. 6.

At 915, the method may include receiving, on a first beam of the first component carrier, a first transmission based on the QCL relationship. The operations of 915 may be performed in accordance with examples as disclosed herein. In some examples, aspects of the operations of 915 may be performed by a first component carrier manager 630 as described with reference to FIG. 6.

At 920, the method may include selecting the second beam of the second component carrier based on receiving the beam activation request from the application. The operations of 920 may be performed in accordance with examples as disclosed herein. In some examples, aspects of the operations of 920 may be performed by an application component 645 as described with reference to FIG. 6.

At 925, the method may include receiving, on a second beam of the second component carrier, a second transmission according to one or more parameters used for receiving the first beam based on the QCL relationship. The operations of 925 may be performed in accordance with examples as disclosed herein. In some examples, aspects of the operations of 925 may be performed by a second component carrier manager 635 as described with reference to FIG. 6.

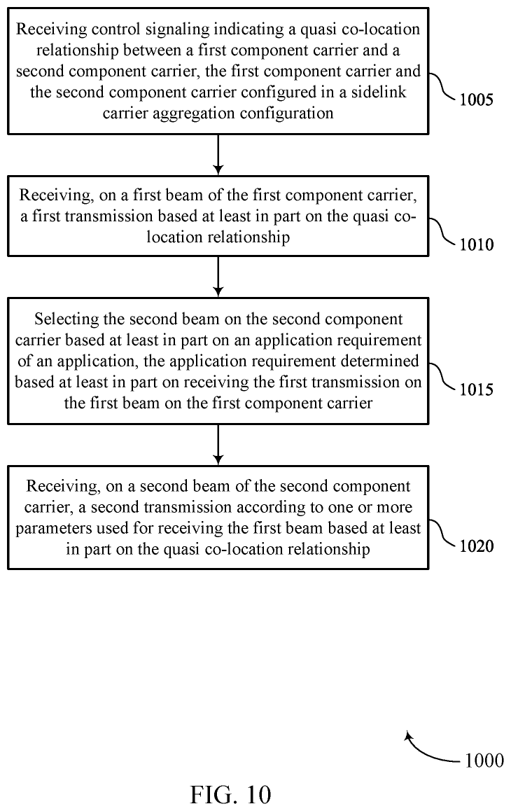

FIG. 10 shows a flowchart illustrating a method 1000 that supports techniques for sidelink carrier aggregation in accordance with aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1005, the method may include receiving control signaling indicating a QCL relationship between a first component carrier and a second component carrier, the first component carrier and the second component carrier configured in a sidelink carrier aggregation configuration. The operations of 1005 may be performed in accordance with examples as disclosed herein. In some examples, aspects of the operations of 1005 may be performed by a QCL configuration component 625 as described with reference to FIG. 6.

At 1010, the method may include receiving, on a first beam of the first component carrier, a first transmission based on the QCL relationship. The operations of 1010 may be performed in accordance with examples as disclosed herein. In some examples, aspects of the operations of 1010 may be performed by a first component carrier manager 630 as described with reference to FIG. 6.

At 1015, the method may include selecting the second beam on the second component carrier based on an application requirement of an application, the application requirement determined based on receiving the first transmission on the first beam on the first component carrier. The operations of 1015 may be performed in accordance with examples as disclosed herein. In some examples, aspects of the operations of 1015 may be performed by an application component 645 as described with reference to FIG. 6.

At 1020, the method may include receiving, on a second beam of the second component carrier, a second transmission according to one or more parameters used for receiving the first beam based on the QCL relationship. The operations of 1020 may be performed in accordance with examples as disclosed herein. In some examples, aspects of the operations of 1020 may be performed by a second component carrier manager 635 as described with reference to FIG. 6.

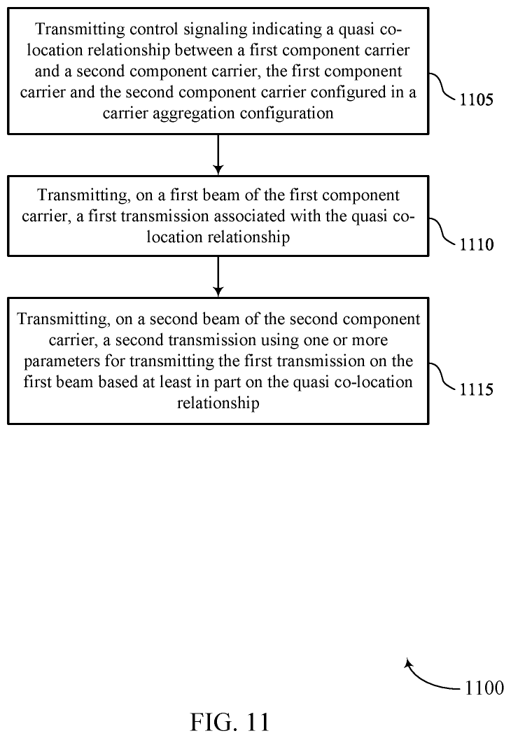

FIG. 11 shows a flowchart illustrating a method 1100 that supports techniques for sidelink carrier aggregation in accordance with aspects of the present disclosure. The operations of the method 1100 may be implemented by a UE or its components as described herein. For example, the operations of the method 1100 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1105, the method may include transmitting control signaling indicating a QCL relationship between a first component carrier and a second component carrier, the first component carrier and the second component carrier configured in a carrier aggregation configuration. The operations of 1105 may be performed in accordance with examples as disclosed herein. In some examples, aspects of the operations of 1105 may be performed by a QCL relationship configuring component 640 as described with reference to FIG. 6.

At 1110, the method may include transmitting, on a first beam of the first component carrier, a first transmission associated with the QCL relationship. The operations of 1110 may be performed in accordance with examples as disclosed herein. In some examples, aspects of the operations of 1110 may be performed by a first component carrier manager 630 as described with reference to FIG. 6.

At 1115, the method may include transmitting, on a second beam of the second component carrier, a second transmission using one or more parameters for transmitting the first transmission on the first beam based on the QCL relationship. The operations of 1115 may be performed in accordance with examples as disclosed herein. In some examples, aspects of the operations of 1115 may be performed by a second component carrier manager 635 as described with reference to FIG. 6.

The following provides an overview of aspects of the present disclosure:

Aspect 1: A method for wireless communications at a UE, comprising: receiving control signaling indicating a quasi co-location relationship between a first component carrier and a second component carrier, the first component carrier and the second component carrier configured in a sidelink carrier aggregation configuration; receiving, on a first beam of the first component carrier, a first transmission based at least in part on the quasi co-location relationship; receiving, on a second beam of the second component carrier, a second transmission according to one or more parameters used for receiving the first beam based at least in part on the quasi co-location relationship.

Aspect 2: The method of aspect 1, further comprising: receiving a beam activation request from an application at the UE; and selecting the second beam of the second component carrier based at least in part on receiving the beam activation request from the application.

Aspect 3: The method of any of aspects 1 through 2, wherein receiving the second transmission comprises: receiving the second transmission using a spatial receive configuration of the first beam based at least in part on the quasi co-location relationship.

Aspect 4: The method of any of aspects 1 through 3, wherein receiving the control signaling comprises: receiving an indication that the first transmission on a first set of resources is quasi co-located with the second transmission on a second set of resources.

Aspect 5: The method of any of aspects 1 through 4, wherein receiving the control signaling comprises: receiving an indication that the first transmission is quasi co-located with the second transmission based at least in part on a time offset between the first transmission and the second transmission.

Aspect 6: The method of any of aspects 1 through 5, wherein receiving the second transmission comprises: receiving the second transmission on the second beam that has a different beam size than the first beam according to the one or more parameters based at least in part on the quasi co-location relationship.

Aspect 7: The method of aspect 6, wherein the second beam is wider than the first beam, or the first beam is wider than the second beam.

Aspect 8: The method of any of aspects 1 through 7, wherein receiving the first transmission comprises: receiving, in the first transmission, an indication that the second transmission is quasi co-located with the first transmission based at least in part on the quasi co-location relationship between the first component carrier and the second component carrier.

Aspect 9: The method of aspect 8, wherein one or more bits in a physical broadcast channel of the first transmission include the indication that the second transmission is quasi co-located with the first transmission.

Aspect 10: The method of any of aspects 1 through 9, wherein receiving the second transmission comprises: receiving, in the second transmission, an indication that the second transmission is quasi co-located with the first transmission based at least in part on the quasi co-location relationship between the first component carrier and the second component carrier.

Aspect 11: The method of any of aspects 1 through 10, further comprising: determining the first transmission is quasi co-located with the second transmission based at least in part a first beam width for the first transmission on the first component carrier indicating the quasi co-location relationship.

Aspect 12: The method of any of aspects 1 through 11, further comprising: selecting the second beam on the second component carrier based at least in part on an application requirement of an application, the application requirement determined based at least in part on receiving the first transmission on the first beam on the first component carrier.

Aspect 13: The method of aspect 12, wherein the application is associated with a plurality of application requirements corresponding to a plurality of component carriers including at least the first component carrier and the second component carrier.

Aspect 14: The method of any of aspects 12 through 13, wherein the application requirement is based at least in part on a communication range or a communication range accuracy, or both.

Aspect 15: The method of any of aspects 1 through 14, wherein the first transmission includes a first type of signaling which is quasi co-located with a second type of signaling in the second transmission, wherein the first type of signaling is different from the second type of signaling.

Aspect 16: The method of any of aspects 1 through 15, wherein the first transmission or the second transmission, or both, include a synchronization signal block, a channel state information reference signal, a sounding reference signal, or any combination thereof.

Aspect 17: The method of any of aspects 1 through 16, wherein the first component carrier corresponds to a first frequency range and the second component carrier corresponds to a second frequency range, wherein the first frequency range is different from the second frequency range.

Aspect 18: A method for wireless communications at a UE, comprising: transmitting control signaling indicating a quasi co-location relationship between a first component carrier and a second component carrier, the first component carrier and the second component carrier configured in a carrier aggregation configuration; transmitting, on a first beam of the first component carrier, a first transmission associated with the quasi co-location relationship; transmitting, on a second beam of the second component carrier, a second transmission using one or more parameters for transmitting the first transmission on the first beam based at least in part on the quasi co-location relationship.

Aspect 19: The method of aspect 18, wherein transmitting the second transmission comprises: transmitting the second transmission using a spatial filter configuration of the first beam based at least in part on the quasi co-location relationship.

Aspect 20: The method of any of aspects 18 through 19, wherein transmitting the control signaling comprises: transmitting an indication that the first transmission on a first set of resources is quasi co-located with the second transmission on a second set of resources.

Aspect 21: The method of any of aspects 18 through 20, wherein transmitting the control signaling comprises: transmitting an indication that the first transmission is quasi co-located with the second transmission based at least in part on a time offset between the first transmission and the second transmission.

Aspect 22: The method of any of aspects 18 through 21, wherein transmitting the second transmission comprises: transmitting the second transmission on the second beam that has a different beam size than the first beam according to the one or more parameters based at least in part on the quasi co-location relationship.

Aspect 23: The method of aspect 22, wherein the second beam is wider than the first beam, or the first beam is wider than the second beam.

Aspect 24: The method of any of aspects 18 through 23, wherein transmitting the first transmission comprises: transmitting, in the first transmission, an indication that the second transmission is quasi co-located with the first transmission based at least in part on the quasi co-location relationship between the first component carrier and the second component carrier.

Aspect 25: The method of aspect 24, further comprising: including the indication that the second transmission is quasi co-located with the first transmission in a physical broadcast channel of the first transmission.

Aspect 26: The method of any of aspects 18 through 25, wherein transmitting the second transmission comprises: transmitting, in the second transmission, an indication that the second transmission is quasi co-located with the first transmission based at least in part on the quasi co-location relationship between the first component carrier and the second component carrier.

Aspect 27: The method of any of aspects 18 through 26, further comprising: indicating that the first transmission is quasi co-located with the second transmission based at least in part a first beam width for the first transmission on the first component carrier indicating the quasi co-location relationship.

Aspect 28: The method of any of aspects 18 through 27, wherein the first transmission includes a first type of signaling which is quasi co-located with a second type of signaling in the second transmission, wherein the first type of signaling is different from the second type of signaling.

Aspect 29: An apparatus for wireless communications at a UE, comprising a processor; memory coupled with the processor; and instructions stored in the memory and executable by the processor to cause the apparatus to perform a method of any of aspects 1 through 17.

Aspect 30: An apparatus for wireless communications at a UE, comprising at least one means for performing a method of any of aspects 1 through 17.

Aspect 31: A non-transitory computer-readable medium storing code for wireless communications at a UE, the code comprising instructions executable by a processor to perform a method of any of aspects 1 through 17.

Aspect 32: An apparatus for wireless communications at a UE, comprising a processor; memory coupled with the processor; and instructions stored in the memory and executable by the processor to cause the apparatus to perform a method of any of aspects 18 through 28.

Aspect 33: An apparatus for wireless communications at a UE, comprising at least one means for performing a method of any of aspects 18 through 28.

Aspect 34: A non-transitory computer-readable medium storing code for wireless communications at a UE, the code comprising instructions executable by a processor to perform a method of any of aspects 18 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving control signaling indicating a quasi co-location relationship between a first component carrier and a second component carrier, the first component carrier and the second component carrier configured in a sidelink carrier aggregation configuration;
receiving, on a first beam of the first component carrier, a first transmission based at least in part on the quasi co-location relationship;
receiving, on a second beam of the second component carrier, a second transmission according to one or more parameters used for receiving the first beam based at least in part on the quasi co-location relationship.

2. The method of claim 1, further comprising:
receiving a beam activation request from an application at the UE; and
selecting the second beam of the second component carrier based at least in part on receiving the beam activation request from the application.

3. The method of claim 1, wherein receiving the second transmission comprises:
receiving the second transmission using a spatial receive configuration of the first beam based at least in part on the quasi co-location relationship.

4. The method of claim 1, wherein receiving the control signaling comprises:
receiving an indication that the first transmission on a first set of resources is quasi co-located with the second transmission on a second set of resources.

5. The method of claim 1, wherein receiving the control signaling comprises:
receiving an indication that the first transmission is quasi co-located with the second transmission based at least in part on a time offset between the first transmission and the second transmission.

6. The method of claim 1, wherein receiving the second transmission comprises:
receiving the second transmission on the second beam that has a different beam size than the first beam according to the one or more parameters based at least in part on the quasi co-location relationship.

7. The method of claim 6, wherein the second beam is wider than the first beam, or the first beam is wider than the second beam.

8. The method of claim 1, wherein receiving the first transmission comprises:
receiving, in the first transmission, an indication that the second transmission is quasi co-located with the first transmission based at least in part on the quasi co-location relationship between the first component carrier and the second component carrier.

9. The method of claim 8, wherein one or more bits in a physical broadcast channel of the first transmission include the indication that the second transmission is quasi co-located with the first transmission.

10. The method of claim 1, wherein receiving the second transmission comprises:
receiving, in the second transmission, an indication that the second transmission is quasi co-located with the first transmission based at least in part on the quasi co-location relationship between the first component carrier and the second component carrier.

11. The method of claim 1, further comprising:
determining the first transmission is quasi co-located with the second transmission based at least in part a first beam width for the first transmission on the first component carrier indicating the quasi co-location relationship.

12. The method of claim 1, further comprising:
selecting the second beam on the second component carrier based at least in part on an application requirement of an application, the application requirement determined based at least in part on receiving the first transmission on the first beam on the first component carrier.

13. The method of claim 12, wherein the application is associated with a plurality of application requirements corresponding to a plurality of component carriers including at least the first component carrier and the second component carrier.

14. The method of claim 12, wherein the application requirement is based at least in part on a communication range or a communication range accuracy, or both.

15. The method of claim 1, wherein the first transmission includes a first type of signaling which is quasi co-located with a second type of signaling in the second transmission, wherein the first type of signaling is different from the second type of signaling.

16. The method of claim 1, wherein the first transmission or the second transmission, or both, include a synchronization signal block, a channel state information reference signal, a sounding reference signal, or any combination thereof.

17. The method of claim 1, wherein the first component carrier corresponds to a first frequency range and the second component carrier corresponds to a second frequency range, wherein the first frequency range is different from the second frequency range.

18. A method for wireless communications at a user equipment (UE), comprising:
transmitting control signaling indicating a quasi co-location relationship between a first component carrier and a second component carrier, the first component carrier and the second component carrier configured in a carrier aggregation configuration;
transmitting, on a first beam of the first component carrier, a first transmission associated with the quasi co-location relationship;
transmitting, on a second beam of the second component carrier, a second transmission using one or more parameters for transmitting the first transmission on the first beam based at least in part on the quasi co-location relationship.

19. The method of claim 18, wherein transmitting the second transmission comprises:
transmitting the second transmission using a spatial filter configuration of the first beam based at least in part on the quasi co-location relationship.

20. The method of claim 18, wherein transmitting the control signaling comprises:
transmitting an indication that the first transmission on a first set of resources is quasi co-located with the second transmission on a second set of resources.

21. The method of claim 18, wherein transmitting the control signaling comprises:
transmitting an indication that the first transmission is quasi co-located with the second transmission based at least in part on a time offset between the first transmission and the second transmission.

22. The method of claim 18, wherein transmitting the second transmission comprises:
transmitting the second transmission on the second beam that has a different beam size than the first beam according to the one or more parameters based at least in part on the quasi co-location relationship.

23. The method of claim 22, wherein the second beam is wider than the first beam, or the first beam is wider than the second beam.

24. The method of claim 18, wherein transmitting the first transmission comprises:
transmitting, in the first transmission, an indication that the second transmission is quasi co-located with the first transmission based at least in part on the quasi co-location relationship between the first component carrier and the second component carrier.

25. The method of claim 24, further comprising:
including the indication that the second transmission is quasi co-located with the first transmission in a physical broadcast channel of the first transmission.

26. The method of claim 18, wherein transmitting the second transmission comprises:
transmitting, in the second transmission, an indication that the second transmission is quasi co-located with the first transmission based at least in part on the quasi co-location relationship between the first component carrier and the second component carrier.

27. The method of claim 18, further comprising:
indicating that the first transmission is quasi co-located with the second transmission based at least in part a first beam width for the first transmission on the first component carrier indicating the quasi co-location relationship.

28. The method of claim 18, wherein the first transmission includes a first type of signaling which is quasi co-located with a second type of signaling in the second transmission, wherein the first type of signaling is different from the second type of signaling.

29. An apparatus for wireless communications at a user equipment (UE), comprising:
a processor;
memory coupled with the processor; and
instructions stored in the memory and executable by the processor to cause the apparatus to:
receive control signaling indicating a quasi co-location relationship between a first component carrier and a second component carrier, the first component carrier and the second component carrier configured in a sidelink carrier aggregation configuration;
receive, on a first beam of the first component carrier, a first transmission based at least in part on the quasi co-location relationship;
receive, on a second beam of the second component carrier, a second transmission according to one or more parameters used for receiving the first beam based at least in part on the quasi co-location relationship.

30. An apparatus for wireless communications at a user equipment (UE), comprising:
a processor;
memory coupled with the processor; and
instructions stored in the memory and executable by the processor to cause the apparatus to:
transmit control signaling indicating a quasi co-location relationship between a first component carrier and a second component carrier, the first component carrier and the second component carrier configured in a carrier aggregation configuration;
transmit, on a first beam of the first component carrier, a first transmission associated with the quasi co-location relationship;
transmit, on a second beam of the second component carrier, a second transmission using one or more parameters for transmitting the first transmission on the first beam based at least in part on the quasi co-location relationship.
